(19) United States
(12) Patent Application Publication
(10) Pub. No.: US 2015/0065109 A1
(43) Pub. Date: Mar. 5, 2015

(54) ENHANCED IDLE MODE MECHANISMS FOR POWER EFFICIENT DEVICES

(71) Applicant: QUALCOMM Incorporated, San Diego, CA (US)

(72) Inventors: Sitaramanjaneyulu KANAMARLAPUDI, San Diego, CA (US); Uzma Khan Qazi, San Marcos, CA (US); Liangchi Hsu, San Diego, CA (US)

(73) Assignee: QUALCOMM Incorporated, San Diego, CA (US)

(21) Appl. No.: 14/260,104

(22) Filed: Apr. 23, 2014

Related U.S. Application Data
(60) Provisional application No. 61/872,401, filed on Aug. 30, 2013.

(51) Int. Cl. H04W 52/02

(52) U.S. Cl. CPC H04W 52/0225
USPC 455/418

(57) ABSTRACT

Methods and apparatuses for improved power management of a user equipment (UE) are presented. In an aspect, an example method is presented that includes detecting a first trigger event, transitioning an operational mode of the UE from a first mode to a second mode based on detecting the first trigger event, wherein a paging cycle rate and a cell measurement rate of the UE are based on the operational mode of the UE. The example method further includes monitoring a paging channel of a serving cell associated with the UE according to the paging cycle rate and performing cell measurement of one or more available cells according to the cell measurement rate while the UE is operating according to the second mode. Furthermore, the example method includes detecting a second trigger event and transitioning the operational mode of the UE from the second mode to the first mode.

### CROSS-REFERENCE TO RELATED APPLICATIONS

This application claims the benefit under 35 U.S.C. §119 to U.S. Provisional Patent Application Ser. No. 61/872,401 entitled “ENHANCED IDLE MODE MECHANISMS FOR POWER EFFICIENT DEVICE,” which was filed on Aug. 30, 2013, the entirety of which is hereby incorporated by reference.

### BACKGROUND

The following description relates generally to wireless communications, and more particularly to providing multiple operational modes for a user equipment (UE) for improved power management.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

Currently, in UMTS systems, a UE camps on an appropriate cell using methods of cell selection and/or reselection as specified, for example, in Third Generation Partnership Project (3GPP) publication TS25.304, which is hereby incorporated by reference. For example, when operating in idle mode, the UE may need to perform various intra-frequency, inter-frequency, and inter-radio access technology (RAT) measurements to aid in executing the appropriate cell selection and/or reselection algorithm. The types of measurements, the UE state, and the UE receiver capabilities determine when such measurements may be taken. For example, intra-frequency measurements may be taken while continuing to receive data from the serving cell. In addition, the UE may need to monitor the network for paging occasions according to a configured discontinuous reception (DRX) cycle length specified by the network. The paging occasions, at which the UE may have incoming paging messages on a paging channel (PCH), are indicated by paging indicators which are carried via a Paging Indicator Channel (PICH).

If the UE has only one receiver, inter-frequency and inter-RAT measurements, as well as monitoring the PICH for paging occasions, require the UE to retune its radio, and thus prevent the UE from receiving data from the serving cell while taking measurements of available cells or monitoring the PICH. While the UE remains in idle mode or PCH state, performing these measurements and monitoring paging occasions are major contributors to UE power consumption.

### SUMMARY

The following presents a simplified summary of one or more aspects of the disclosure in-order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to example aspects, a method for UE management is presented which may result in reduced UE power consumption due to the potential for the UE to effectively skip one or more paging or cell measurement iterations. In an aspect, such an example method may include detecting a first trigger event and transitioning an operational mode of the UE from a first mode to a second mode based on detecting the first trigger event, wherein a paging cycle rate and a cell measurement rate of the UE are based on the operational mode. In an additional aspect, such an example method may include monitoring a paging channel of a serving cell associated with the UE according to the paging cycle rate while the UE is operating according to the second mode and performing cell measurement of one or more available cells according to the cell measurement rate while the UE is operating according to the second mode. Likewise, the example method may include detecting a second trigger event while the UE is operating according to the second mode and transitioning the operational mode of the UE from the second mode to the first mode based on detecting the second trigger event.

In a further example aspect, the present disclosure presents an apparatus for mobile communication, which may include means for detecting a first trigger event and means for transitioning an operational mode of the UE from a first mode to a second mode based on detecting the first trigger event, wherein a paging cycle rate and a cell measurement rate of the UE are based on the operational mode of the UE. Such an example apparatus may further include means for monitoring a paging channel of a serving cell associated with the UE according to the paging cycle rate while the UE is operating according to the second mode and means for performing cell measurement of one or more available cells according to the cell measurement rate while the UE is operating according to the second mode. Furthermore, the example apparatus may include means for detecting a second trigger event while the UE is operating according to the second mode and means for transitioning the operational mode of the UE from the second mode to the first mode based on detecting the second trigger event.

Additionally, the present disclosure presents a non-transitory computer-readable storage medium, comprising instructions, that when executed by a processor, cause the processor to perform detecting a first trigger event, transitioning an operational mode of the UE from a first mode to a second mode based on detecting the first trigger event, wherein a paging cycle rate and a cell measurement rate of the UE are based on the operational mode, monitoring a paging channel of a serving cell associated with the UE according to the paging cycle rate while the UE is operating according to the second mode, performing cell measurement of one or more available cells according to the cell measurement rate while the UE is operating according to the second mode, detecting a second trigger event while the UE is operating according to the second mode, and transitioning the operational mode of the UE from the second mode to the first mode based on detecting the second trigger event.

Moreover, the present disclosure presents an apparatus for management of a UE, which may include a trigger event detecting component configured to detect a first trigger event and a second trigger event and an operational mode transitioning component configured to transition an operational mode of the UE from a first mode to a second mode based on detecting the first trigger event and configured to transition the operational mode from the second mode to the first mode based on detecting the second trigger event, wherein a paging cycle rate and a cell measurement rate of the UE are based on the operational mode of the UE. In addition, the example apparatus may include a paging channel monitoring component configured to monitor a paging channel of a serving cell associated with the UE according to the paging cycle rate while the UE is operating according to the second mode and a cell measurement component configured to perform cell measurement of one or more available cells according to the cell measurement rate while the UE is operating according to the second mode;

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is a block diagram conceptually illustrating an example wireless communications system according to the present disclosure;

FIG. 2 is a block diagram conceptually illustrating an example operational mode manager according to an example apparatus of the present disclosure;

FIG. 3A is a flow diagram comprising a plurality of functional blocks representing an example methodology of the present disclosure;

FIG. 3B is a flow diagram comprising a plurality of functional blocks representing another example methodology of the present disclosure;

FIG. 4 is a block diagram conceptually illustrating an example of a hardware implementation for an apparatus employing a processing system;

FIG. 5 is a block diagram conceptually illustrating an example of a telecommunications system;

FIG. 6 is a diagram conceptually illustrating an example of an access network; and

FIG. 7 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure presents methods and apparatuses for improved power management and performance in UEs. For example, according to example methods and apparatuses of the present disclosure, when a UE is operating in idle mode or PCH state, the UE may transition between operational modes, which may include a passive mode and an active mode. By utilizing these example methods and apparatuses, UE power consumption associated with monitoring the network for paging occasions and cell reselection opportunities can be decreased.

In an aspect of the present disclosure, a server may be configured to generate a message or command that moves the UE between operational modes, such as a first mode and a second mode, each of which may be an active mode or a passive mode. In the active mode, relatively high volume of communication activity may be expected between the UE and a network and/or server, such as, but not limited to, when a UE is conducting a voice call, streaming data session, or the like. During the active mode, to maintain call or session integrity, relatively few instances of cell measurement and paging occasion monitoring can be skipped in order to ensure reliable cell selection/reselection and page channel decoding processes.

Conversely, in the passive mode, a relatively low volume of communication activity may be expected. Thus, while a UE operational mode is a passive mode, a number of cell measurement and/or paging channel (or paging indicator channel) monitoring instances can be skipped while maintaining proper UE functionality. By skipping one or more paging channel monitoring or cell measurement instances, the UE may save battery power that may have been consumed were the UE to perform every instance of page monitoring or cell measurement. Furthermore, where pages are tied to non-time-critical data (e.g., a magazine subscription, book download, etc.) rather than time-critical data (e.g., voice call, streaming audio or video), a UE can benefit from the power savings advantage of transitioning to the passive mode of the present disclosure without significant risk to call integrity because a delay in downloading the non-time-critical data resulting from skipped paging instances may be acceptable.

The generation and/or transmission of a command to transition between operational modes may be timer-based, event-based, or time-of-day based. For example, for time-of-day based triggering, the UE or server may generate the message or command to transition the UE from a first mode (e.g., passive mode) into a second mode (e.g., active mode) at a predetermined time of day during which a large amount of downlink traffic is normally present for a UE. For example, the server (e.g., a magazine subscription server or other non-critical data content server) may normally push data to subscribers during the middle of the night when network bandwidth cost is lowest. Thus, during these times (e.g., 1:00-2:00 AM or the like), the UE may transition into active mode to receive the content.

In another optional aspect, the UE or server may generate a message or command to transition the UE from the passive mode into the active mode based on an “event,” such as when the UE or server determines that data exists at the server which is ready to be transmitted, or “pushed,” to the UE. For example, using the magazine subscription example, the server, or an application executed on the server, may transmit a message to move the UE to active mode where the server determines that the magazine is ready to be pushed to the UE. Likewise, the UE can exit a current mode based on the expiration a pre-determined amount of time after entering the current mode.

In an additional aspect of the present disclosure, a UE may depart from existing cell selection protocol by reselecting, regardless of the mobility state of the UE, to the largest cell detected by the UE in a cell measurement procedure. For example, an Information Element (IE) exists in the radio resource control (RRC) layer called the “UE Mobility State Indicator,” which is generated and transmitted by the UE to indicate whether the UE is operating in a high mobility state or a low mobility state based on certain criteria defined by the network configuration. In an aspect, a high mobility state may indicate that a UE is rapidly transitioning between cells, while a medium, normal, or low mobility state may indicate that the UE is transitioning between cells relatively slowly vis-à-vis a high mobility state UE. This mobility state may be based, for example, on a number of cell reselections or handovers during a specified period of time. Furthermore, with Hierarchical Cell Structure (HCS) supported configurations, the UE knows the cells that belong to larger or smaller coverage areas based on HCS priority values given in System Information Block (SIB) messages transmitted by each cell of the network. According to the current standards, high mobility state UEs are expected to be served by a large cell while the low mobility UEs are expected to be served by a small cell.

In addition, the number of times that the UE can skip cell measurement or page monitoring occasions can be dependent on the size of the cell. For example, when camped on a large cell, UE is permitted to skip the measurements quite often compared to if the UE were camped on a medium cell or small cell. Thus, the number of times the UE is permitted to skip the cell measurements or page monitoring occasions can be dependent on the current status of the “UE Mobility State Indicator.” Specifically, if the UE is in a high mobility state, UE can camp on a large cell and thereby maximize the number of skipped cell measurements or page monitoring occasions compared to where the UE is in a low mobility state.

Thus, in an additional or alternative aspect of the present disclosure, even though a UE is a low mobility user, the UE can be configured to camp on the largest available cell detected during a cell measurement procedure. As such, because the UE is camped on the largest available cell, the UE can skip a larger number of paging occasions and cell measurements relative to small or medium cells, which helps to improve the battery performance.

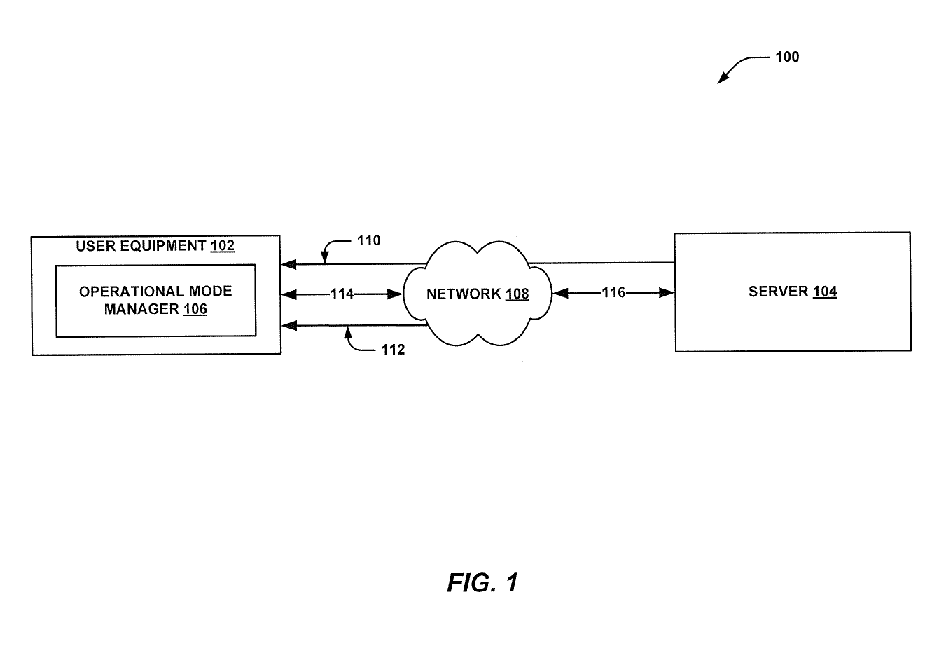

FIG. 1 is a schematic diagram illustrating a system 100 for wireless communication, according to an example configuration. FIG. 1 includes an example network 108, which may communicate wirelessly with a UE 102 over one or more wireless communication channels 114, which may include, in a non-limiting aspect, data communication channels, paging channels, and/or control channels. In an aspect, communication channels 114 may include a paging channel (PCH) and/or a paging indicator channel (PICH). For purposes of the present disclosure, any reference to a paging channel may include a paging channel or a paging indicator channel. In other words, when UE 102 monitors a paging channel according to the present disclosure, the UE may likewise monitor a paging indicator channel.

In an additional aspect, communication channel 114 comprise any over-the-air (OTA) communication channel, including, but not limited to, one or more data or control communication channels operating according to specifications promulgated by 3GPP and/or 3GPP2, which may include first generation, second generation (2G), 3G, 4G, etc. wireless network communication protocols. In addition, one or more cells or network entities associated with the one or more cells of network 108 may be configured to broadcast or otherwise transmit system information 112 associated with the one or more cells. In an aspect, the system information 112 may include SIBs, connectivity or permission information, cell size or geographical information (e.g., HCS or other cell priority information), cell identification information, or any other cell-specific information. For purposes of the present disclosure, “cell size” may refer to a geographic or spatial area over which a cell is able to provide communication services to one or more UEs 102. Likewise, “largest cell size” may refer to a cell size of a plurality of cell sizes that encompasses the largest geographic or spatial area over which the cell is able to provide communication services to one or more UEs 102.

Furthermore, network 108 may communicate with a server 104 over one or more communication links 116. Server 104 may be configured to transmit data, messages, or otherwise communicate with UE 102 via network 108. In an aspect, server 104 may include a memory (not shown) that serves as a data repository for data, messages, subscription content (e.g., books, magazines, music, multimedia, or the like) that may be transmitted from the server 104 to UE 102 over network 108. In addition, server 104 may be configured to transmit one or more messages 110 to UE 102 to indicate that a data stored on the server is to be transmitted, or “pushed,” to the UE 102. In some examples, such messages 110 may be associated with upper layers of a communication layer model (e.g., the Open Systems Interconnection (OSI) model), which may include, but is not limited to, an application layer or layer 7. In an additional aspect the one or more messages 110 may include one or more paging signals, which may be forwarded to UE 102 via network 108.

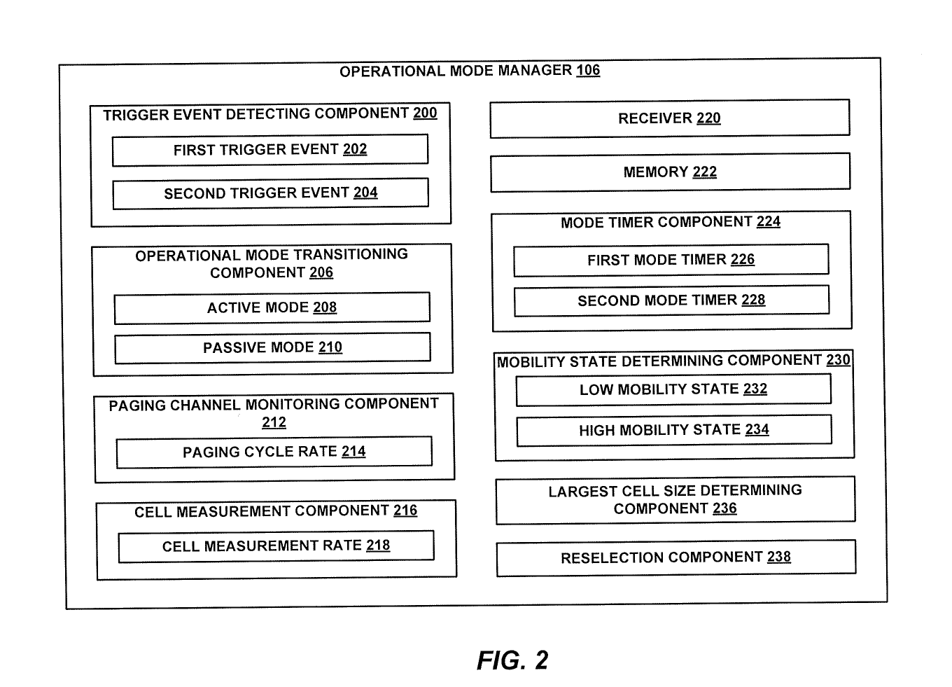

Additionally, UE 102 may comprise any type of mobile device, such as, but not limited to, a smartphone, cellular telephone, mobile phone, laptop computer, tablet computer, e-reader, or other portable networked device. In addition, UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In general, UE 102 may be small and light enough to be considered portable and may be configured to communicate wirelessly via an over-the-air communication link using one or more OTA communication protocols described herein. Alternatively or additionally, UE 102 may comprise a relatively stationary device, such as, but not limited to, a Machine-to-Machine (M2M) device. In addition, UE 102 may include an operational mode manager 106, which may be configured to transition the UE 102 between a plurality of available operational modes, each of which may define the paging cycle and cell monitoring behavior of UE 102 while UE 102 is operating according to a given operational mode. Operational mode manager 106 is discussed in greater detail below in reference to FIG. 2. Furthermore, though not shown in FIG. 1, server 104 may include the operational mode manager 106 and may be configured to perform methods disclosed herein.

Furthermore, network 108 of FIG. 1 may include one or more of any type of network entity or module, such as an access point, a macro cell, including a base station (BS), node B, eNodeB (eNB), a relay, a peer-to-peer device, an authentication, authorization and accounting (AAA) server, a mobile switching center (MSC), a radio network controller (RNC), or a small cell. As used herein, the term “small cell” may refer to an access point or to a corresponding coverage area of the access point, where the access point in this case has a relatively low transmit power or relatively small coverage as compared to, for example, the transmit power or coverage area of a macro network access point or macro cell. For instance, a macro cell may cover a relatively large geographic area, such as, but not limited to, several kilometers in radius. In contrast, a small cell may cover a relatively small geographic area, such as, but not limited to, a home, a building, or a floor of a building. As such, a small cell may include, but is not limited to, an apparatus such as a base station (BS), an access point, a femto node, a femtocell, a pico node, a micro node, a Node B, evolved Node B (eNB), home Node B (HNB) or home evolved Node B (HeNB). Therefore, the term “small cell,” as used herein, refers to a relatively low transmit power and/or a relatively small coverage area cell as compared to a macro cell. Additionally, network 108 may communicate with one or more other network entities of wireless and/or core networks. Furthermore, the one or more network entities of network 108 may transmit

Additionally, network 108 may include any network type, such as, but not limited to, wide-area networks (WAN), wireless networks (e.g. 802.11 or cellular network), the Public Switched Telephone Network (PSTN) network, ad hoc networks, personal area networks (e.g. Bluetooth®) or other combinations or permutations of network protocols and network types. Such network(s) may include a single local area network (LAN) or wide-area network (WAN), or combinations of LANs or WANs, such as the Internet. Such networks may comprise a Wideband Code Division Multiple Access (W-CDMA) system, and may communicate with one or more UEs 102 according to this standard. As those skilled in the art will readily appreciate, various aspects described throughout this disclosure may be extended to other telecommunication systems, network architectures and communication standards. By way of example, various aspects may be extended to other Universal Mobile Telecommunications System (UMTS) systems such as Time Division Synchronous Code Division Multiple Access (TD-SCDMA), High Speed Downlink Packet Access (HSDPA), High Speed Uplink Packet Access (HSUPA), High Speed Packet Access Plus (HSPA+) and Time-Division CDMA (TD-CDMA). Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), Institute of Electrical and Electronics Engineers (IEEE) 802.11 (Wi-Fi), IEEE 802.16 (WiMAX™), IEEE 802.20, Ultra-Wideband (UWB), Bluetooth, and/or other suitable systems. The actual telecommunication standard, network architecture, and/or communication standard employed will depend on the specific application and the overall design constraints imposed on the system. The various devices coupled to the network(s) (e.g., UE 102, server 104) may be coupled to a core network via one or more wired or wireless connections.

Turning to FIG. 2, an example operational mode manager 106 (of FIG. 1, for example) is presented as comprising a plurality of individual components for carrying out the one or more methods or processes described herein. For example, in an aspect, operational mode manager 106 may include a trigger event detecting component 200, which may be configured to detect one or more trigger events that initiate transition between operational modes. For instance, trigger event detecting component 200 may be configured to detect a first trigger event 202 and/or a second trigger event 204, each of which may initiate an operational mode transition for the UE.

Either or both of first trigger event 202 and second trigger event 204 may correspond to one of several trigger event types contemplated by the present disclosure. For example, in a non-limiting aspect, either trigger event may be event-based, timer-based, or time-of-day based trigger event. In event-based triggering, trigger event detecting component 200 may determine that a message has been received from a server that indicates that data on the server is to be transmitted to the UE. For instance, the server may be configured to periodically push data to the UE, and upon each instance of such a data push, the server may transmit a message to indicate that the data is to be transmitted. In event-based triggering, receipt of such a message may serve as a trigger for transitioning from a passive mode to an active mode such that a paging cycle rate 214 associated with the active mode does not skip, or skips relatively few, paging instances to ensure the data to be pushed is successfully received by the UE. For purposes of the present disclosure, paging cycle rate may refer to a rate at which a receiver 220 is tuned to one or more frequencies associated with a paging channel or paging indicator channel of one or more cells to be monitored for paging messages (or paging indicator messages) such that a UE (or operational mode manager 106 associated with a UE) may obtain an indication that a page exists for the UE. Such a page may indicate that a voice call, data session, messaging session, or any other communication session or call establishment request or indication is present on the network for the UE (e.g., UE 102 of FIG. 1).

In timer-based triggering, the trigger event detecting component 200 may detect that a timer associated with an operational mode has expired, and as such, the operational mode should be transitioned from a first state to a second state or vice versa. For example, if a UE has operated according to the first mode for a predetermined time period, a trigger event may be detected upon expiration of the timer associated with the time period of the first mode. Furthermore, in time-of-day-based triggering, a trigger event detecting component 200 may be configured to detect a trigger event when a current time of day maintained by the UE is equal to a mode transition time of day associated with a mode transition. For instance, where a server is configured to push data to the UE at a certain time of day, the UE may be configured to transition to an active mode at that time of day to ensure that a paging signal associated with the data to be pushed is not skipped or otherwise goes undetected by the UE.

Additionally, operational mode manager 106 may include an operational mode transitioning component 206, which may be configured to transition an operational mode of the UE between a first mode and a second mode, or vice versa, upon detection of a triggering event by triggering event detecting component 200. In other words, operational mode transitioning component 206 may be configured to transition an operational mode of the UE from a first mode to a second mode based on the detection of a first trigger event, and may further configured to transition the operational mode from the second mode to the first mode based on detecting a second trigger event. In an aspect, the operational modes may include a first mode and a second mode, each of which may correspond to an active mode 208 or a passive mode 210. In other words, for purposes of the present disclosure, the first mode may correspond to either the active mode 208 or the passive mode 210. Likewise, the second mode may correspond to either of the active mode 208 or the passive mode 210.

Furthermore, each of the active mode 208 and the passive mode 210 may have an associated paging cycle rate that determines a rate at which the UE monitors a paging channel or paging indicator channel of a cell. In addition, each of the active mode 208 and the passive mode 210 may have an associated cell measurement rate that determines a rate at which the UE performs cell measurement operations. Such cell measurement operations may include tuning receiver 220 to one or more frequencies associated with broadcast channels of one or more cells to be monitored such that cell measurement component 212 (or operational mode manager 106, generally) may obtain control, timing, subscription, provisioning, or any other characteristic information associated with the monitored cell. In an additional aspect, the paging cycle rate 214 associated with the passive mode 210 may be less than a paging signal transmission rate of a paging channel associated with a serving cell that is to be monitored by the UE. For purposes of the present disclosure, a paging signal transmission rate may refer to a rate at which a cell (or base station, sector, or the like) broadcasts or otherwise transmits paging messages or paging indicators via a paging channel or paging indicator channel. In addition, the cell measurement rate 218 associated with the passive mode 210 may be less than a cell information transmission rate associated with the one or more available cells. For purposes of the present disclosure, “one or more available cells” may be defined according to the present disclosure as any cell or group of cells for which the UE can receive system information or are otherwise in communicative range of the UE. As such, when in passive mode, the UE can effectively “skip” one or more paging instances and/or cell measurement procedure instances by maintaining a relatively lower paging cycle rate and cell measurement rate vis-à-vis one or more serving cells and/or available cells.

Conversely, the paging cycle rate 214 associated with the active mode 208 may conform to the paging signal transmission rate associated with a paging channel of a serving cell of the UE. For example, for purposes of the present disclosure, to “conform to” the paging signal transmission rate associated with the paging channel, the paging cycle rate 214 may be the same or substantially the same as the paging signal transmission rate or otherwise consistent with specified paging signal transmission rate parameters provided by the network entity associated with the paging channel. As such, when in active mode, the UE may not skip any (or skip relatively few) paging iterations or DRX cycles associated with the paging channel. Likewise, the cell measurement rate 218 associated with the active mode 208 may conform to the cell information transmission rate associated with one or more available cells. For instance, each available cell may transmit pilots, beacons, or any other signal that may include system information (e.g., System Information Blocks (SIBs)), connectivity information, or control information according to a defined rate or schedule. These transmissions may individually or collectively be referred to as “cell information” and the rate or schedule according to which such cell information is transmitted (or broadcast) by a cell may be referred to as a “cell information transmission rate” for purposes of the present disclosure. When in active mode, the UE may be configured to perform cell measurement to receive and process such signals according to the defined rate or schedule (i.e., not skip any or skip relatively few cell measurement instances) such that cell selection or reselection procedures are optimized.

To perform the paging channel monitoring procedures, operational mode manager 106 may include a paging channel monitoring component 212, which may be configured to monitor one or more paging channels (e.g., associated with a serving cell of the UE) according to the paging cycle rate 214. As introduced above, the paging cycle rate 214 may correspond to a current operational mode of the UE. As such, where the operational mode is a passive mode 210, the paging cycle rate 214 may be less than the paging signal transmission (or retransmission) rate of a paging channel so as to effectively skip one or more paging instances, which may in turn minimize power consumption of the UE. Alternatively, where the operational mode is an active mode 212, the paging cycle rate 214 may conform to the paging signal transmission (or retransmission) rate of a paging signal such that no paging instances are skipped or relatively few paging instances are skipped vis-à-vis the passive mode 210.

Furthermore, operational mode manager 106 may include a cell measurement component 216, which may be configured to perform cell measurement procedures according to the cell measurement rate 218 associated with a current operational mode of the UE. In an aspect, when the current operational mode of the UE is a passive mode 210, cell measurement rate 218 may be less than a cell information transmission rate associated with one or more available cells. Furthermore, when the current operational mode of the UE is an active mode 212, cell measurement rate 218 may conform to a cell information transmission rate associated with one or more available cells. For purposes of the present disclosure, the one or more available cells may include a current serving cell, one or more neighbor cells, and/or any other cell transmitting cell information that is detectable by cell measurement component 216 or any other component of the UE. Furthermore, the cell information may include connectivity information, access permission information, SIBs, information regarding the size of the cell (e.g., HCS information) or any other related information broadcast by a cell or associated network entity.

Moreover, operational mode manager 106 may include a receiver 220, which may be configured to receive one or more wireless signals transmitted by a server, network, network entity (e.g., base station, eNB, small cell), or one or more associated cells. For example, in an aspect, receiver 220 may be configured to receive a command or message from a server or network indicating that an operational mode is to be transitioned from a first mode to a second mode. In an additional aspect, receiver 220 may be configured to receive a message that indicates that data stored on the server is to be transmitted to the UE, such as a data push indication message or page. Likewise, receiver 220 may be configured to receive a message from the server or network that indicates a mode transition time of day at which a mode transition is to occur on a particular day or on a recurring basis. Additionally, receiver 220 may be configured to receive one or more messages from a server or network indicating a first mode time period and/or second mode time period defining a period during which the UE is to maintain a first mode and/or second mode before transitioning to the other mode. Furthermore, the receiver 220 may receive one or more paging signals or system information signals, such as, but not limited to SIBs, according to a paging cycle rate 214 and cell measurement rate 218, respectively. In addition, receiver 220 may comprise a receiver, transceiver, and associated circuitry for receiving, decoding, queuing, decompressing, decrypting, or otherwise processing received signals.

Additionally, operational mode manager 106 may include a memory 222, which may be configured to store information associated with mode transition, trigger events, paging cycle rate 214, cell measurement rate 218, mode-specific timer information, or any other information associated with operational mode manager 106. For example, memory 222 may store a mode transition time of day associated with a first mode or second mode, such as passive mode 208 and/or active mode 210, which may be read by trigger event detecting component 200 to determine a time of day at which a mode transition is to occur. Furthermore, memory 222 may be configured to store information related to cell size of available cells, the mobility state of the UE, or data pushed from a server.

In an additional aspect, operational mode manager 106 may include a mode timer component 224, which may be configured to maintain and/or monitor a first mode timer 226 and second mode timer 228, each of which may include a mode timer associated with an active mode 208 and a passive mode 210. First mode timer 226 may define a first time period during which the UE is to remain in the first mode and second mode timer 228 may define a second time period during which the UE is to remain in the second mode. Additionally, mode timer component 224 may start and maintain the timers and determine when the timers expire, and may forward an indication of the timer expiration to trigger event detecting component 200 for potential trigger event detection.

Moreover, operational mode manager 106 may include a mobility state determining component 230, which may be configured to determine a mobility state of the UE. For example, the mobility state determining component 230 may be configured to determine that the UE is in a low mobility state 232, high mobility state 234, and/or any other mobility state known in the art, such as, but not limited to, medium mobility state, normal mobility state, and the like. In an aspect, the mobility state may be determined according to historical cell information obtained during cell measurement procedures, cell reselection rate information, handover rate information, or any other information known in the art that is used to determine a UE mobility state.

In addition, operational mode manager 106 may include a largest cell size determining component 236, which may be configured to determine a largest cell available and/or detected by the network having a largest cell size. In an aspect, receiver 220 may receive one or SIBs transmitted by one or more cells, where the SIBs each may indicate a cell size associated with the transmitting cell. For example, such cell size information may include HCS information, which may indicate a cell size of the cell, geographical information associated with the cell from which cell size can be determined, or relative priority information associated with the cell (e.g., priority level of 0-7, or the like). The largest cell size determining component 236 may then compare the cell size information received from the one or more cells and determine the largest cell size based on the comparison. Furthermore, operational mode manager 106 may include a reselection component 238, which may be configured to reselect to the largest cell determined by largest cell size determining component. Therefore, because a UE having an associated low mobility state would traditionally not reselect to a large cell where smaller cells are available, but may do according to functional aspects of operational mode manager 106, paging channel monitoring instances and cell measurement instances can be more frequently skipped relative to traditional UE operation, which can result in improved power conservation at the UE.

Through exemplary components of FIG. 2 are presented in reference to operational mode manager 106, they are not exclusive. Instead, operational mode manager 106 may include additional or alternative components configured to perform aspects of the present disclosure and the claims recited below.

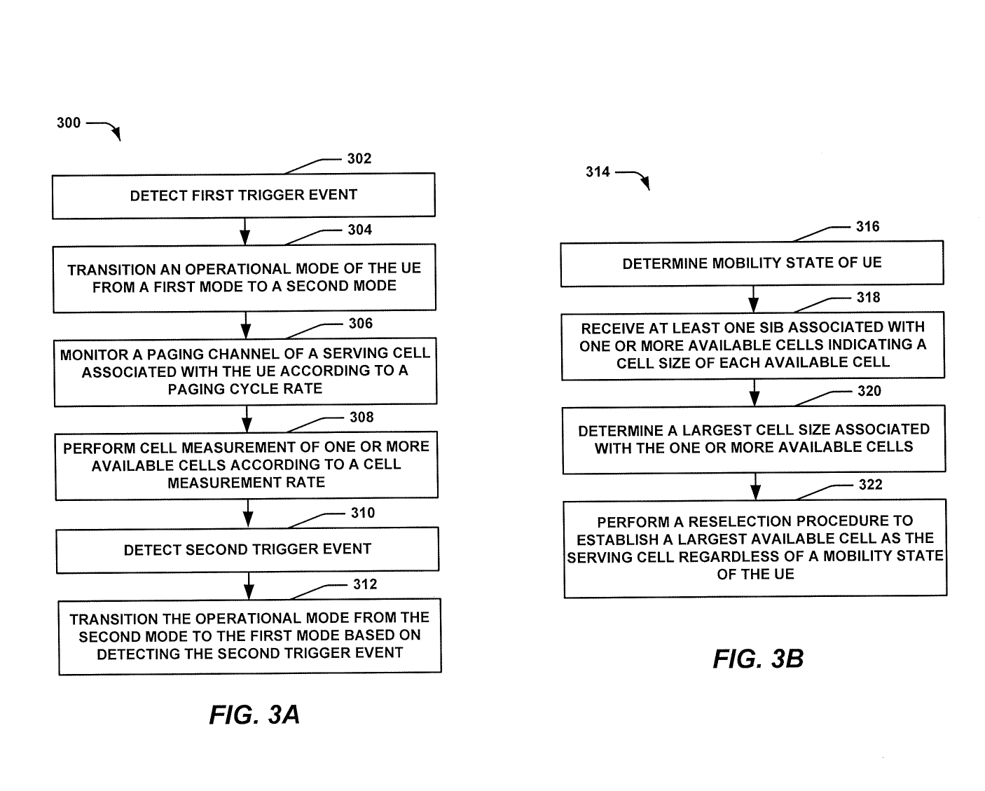

FIGS. 3A and 3B present exemplary methodologies 300 and 314, each comprising a non-limiting set of steps represented as blocks that may be performed by an apparatus described herein (e.g. UE 102 of FIG. 1, operational mode manager 106 of FIGS. 1 and 2, and/or server 104). In an aspect, methodology 300 may comprise a method of user equipment management, and may include, at block 302, detecting a first trigger event. In some examples, block 302 may be performed by trigger event detecting component 200 of FIG. 2. As introduced above, such a trigger event may include a timer-based trigger, time-of-day-based trigger, or an event-based trigger. Furthermore, at the time that first trigger event 302 is detected, a UE may be operating according to a first mode, which may comprise an active mode or passive mode, as described herein.

In addition, at block 304, methodology 300 may include transitioning an operational mode of the UE from a first mode to a second mode based on the detection of the first trigger event. In an aspect, block 304 may be performed by operational mode transitioning component 206 of FIG. 2. In an aspect, the first mode and/or second mode may comprise an active mode or a passive mode, wherein each of the active mode and passive mode have an associated paging cycle rate and cell measurement rate that govern a rate at which the UE monitors a paging channel and a rate at which the UE performs cell measurement procedures, respectively. Furthermore, at block 306, methodology 300 may include monitoring a paging channel of a serving cell associated with the UE according to the paging cycle rate. In some examples, block 306 may be performed by paging channel monitoring component 212 of FIG. 2. In an aspect, where the operational mode is a passive mode, the paging cycle rate may be less than a DRX cycle rate, paging transmission rate, or retransmission rate of a serving cell defining the rate at which the serving cell transmits pages over the paging channel. As such, when in passive mode, the UE may effectively skip one or more paging transmission or retransmission instances and thereby save power associated with performing paging channel monitoring.

In addition, at block 308, methodology 300 may include performing cell measurement of one or more available cells according to the cell measurement rate associated with the current operational mode (e.g. a second mode). In some examples, block 308 may be performed by cell measurement component 216 of FIG. 2. As with the paging cycle rate associated with the passive mode, the cell measurement rate associated with the passive mode may be less than a cell information transmission rate associated with the one or more available cells detected during cell measurement operations.

Moreover, at block 310, methodology 300 may include detecting a second trigger event, for example, while the UE is operating according to a second mode. In some examples, block 310 may be performed by trigger event detecting component 200 of FIG. 2. As with the first trigger event associated with block 302, second trigger event may comprise a timer-based trigger, time-of-day-based trigger, or an event-based trigger. Furthermore, first trigger event of block 302 and second trigger event 310 may include the same type of trigger event or may be different trigger event types. For example, both of the first trigger event and second trigger event may be an event-based trigger, such as receiving a message from a server indicating that data is to be pushed to the UE and/or that data push procedures have completed. In some alternative examples, first trigger event may be an event-based trigger, such as receiving a message from the server, whereas second trigger event may be a timer-based trigger. In such examples, when the UE transitions to the second operational mode at block 304 based on the message from the server, a timer having a time period associated with the operational mode (the timer optionally being stored in memory or received in the message from the server) may be started and may monitor an amount of time that the UE is in the second mode. Absent any intervening information or commands to the contrary, when the timer expires, the second trigger event may be detected at block 310.

Furthermore, at block 312, based on detecting the second trigger event at block 310, methodology 300 may include transitioning the operational mode of the UE from the second mode to the first mode. In some examples, block 312 may be performed by operational mode transitioning component 206 of FIG. 2. Like the second mode, the first mode may comprise an active mode or passive mode as described throughout the present disclosure.

Turning to FIG. 3B, an additional or alternative methodology 314 of the present disclosure is presented for UE management and related power conservation. For purposes of the present disclosure, it is to be understood that methodology 314 may be performed independent of methodology 300, in conjunction with methodology 300, or before, during, or subsequent to methodology 300. In other words, methodology 314 may serve to supplement the power saving aspects of methodology 300 or may serve as a stand-alone method of UE management and power conservation vis-à-vis methodology 300.

In an aspect, methodology 314 may include, at block 316, determining a mobility state associated with a UE. In some examples, block 316 may be performed by mobility state determining component 230 of FIG. 2. As introduced above, such a mobility state may comprise a low mobility state, high mobility state, and/or any other mobility state known in the art, such as, but not limited to, medium mobility state, normal mobility state, and the like. In an aspect, the mobility state may be determined at block 316 according to historical cell information obtained during cell measurement procedures, cell reselection rate information, handover rate information, or any other information known in the art that is used to determine a UE mobility state.

In addition, at block 318, methodology 314 may include receiving at least one SIB associated with one or more available cells, where each of the received SIBs contains a cell size of one of each available cell. In some examples, block 318 may be performed by receiver 220 of FIG. 2. In an aspect, such a cell size may comprise HCS information, which may indicate a cell size of the cell, geographical information associated with the cell from which cell size can be determined, or relative priority information associated with the cell (e.g., priority level of 0-7, or the like). Furthermore, methodology 314 may include, at block 320, determining the largest cell size of the one or more available cells. In some examples, block 320 may be performed by largest cell size determining component 236 of FIG. 2. In an aspect, determining the largest cell size may include comparing the cell size information received from the one or more cells and determine the largest cell size based on the comparison. In addition, methodology 314 may include, at block 322, performing a reselection procedure to establish a largest available cell as the serving cell of the UE regardless of the mobility state of the UE. In some examples, block 322 may be performed by reselection component 238 of FIG. 2. As such, because a UE having an associated low mobility state would traditionally not reselect to a large cell where smaller cells are available, but may do so according to methodology 314, paging channel monitoring instances and cell measurement instances can be more frequently skipped relative to traditional methodologies, which can result in improved power conservation at the UE.

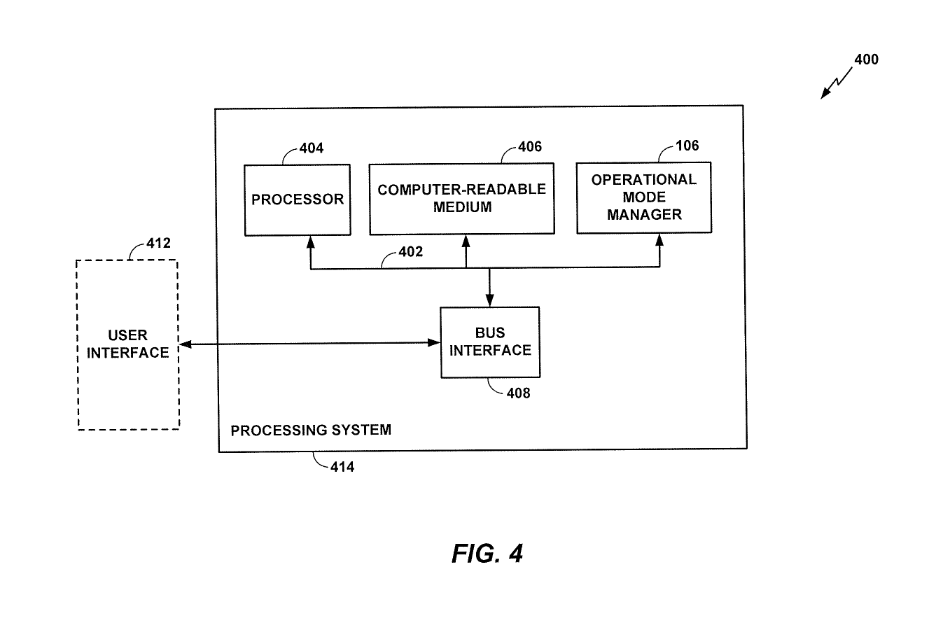

FIG. 4 is a conceptual diagram illustrating an example of a hardware implementation for an apparatus 400 employing a processing system 414. In some examples, the processing system 414 may comprise a UE or a component of a UE (e.g., UE 102 of FIG. 1), or server 104 of FIG. 1. In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits including one or more processors, represented generally by the processor 404, computer-readable media, represented generally by the computer-readable medium 406, and an operational mode manager 106 (see FIGS. 1 and 2), which may be configured to carry out one or more methods or procedures described herein.

The bus 402 may also link various other circuits such as timing sources, peripherals, voltage regulators, and power management circuits, which are well known in the art, and therefore, will not be described any further. Depending upon the nature of the apparatus, a user interface 412 (e.g., keypad, display, speaker, microphone, joystick) may also be provided.

The processor 404 is responsible for managing the bus 402 and general processing, including the execution of software stored on the computer-readable medium 406 and/or a memory (e.g., memory 222 of FIG. 2) of operational mode manager 106. The software, when executed by the processor 404, causes the processing system 414 to perform the various functions described infra for any particular apparatus. The computer-readable medium 406 may also be used for storing data that is manipulated by the processor 404 when executing software.

In addition, operational mode manager 106 may be implemented by processor 404 executing software stored on the computer-readable medium 406 and/or a memory (e.g., memory 222 of FIG. 2) of operational mode manager 106. In other words, in some examples, the operational mode manager 106 may be implemented by software executed by processor 404 in conjunction with computer-readable medium 106. Moreover, operational mode manager 106 may be implemented by a combination of hardware and software. For example, operational mode manager 106 may be partially or wholly implemented by processor 404 or partially or wholly implemented by hardware other than processor 404.

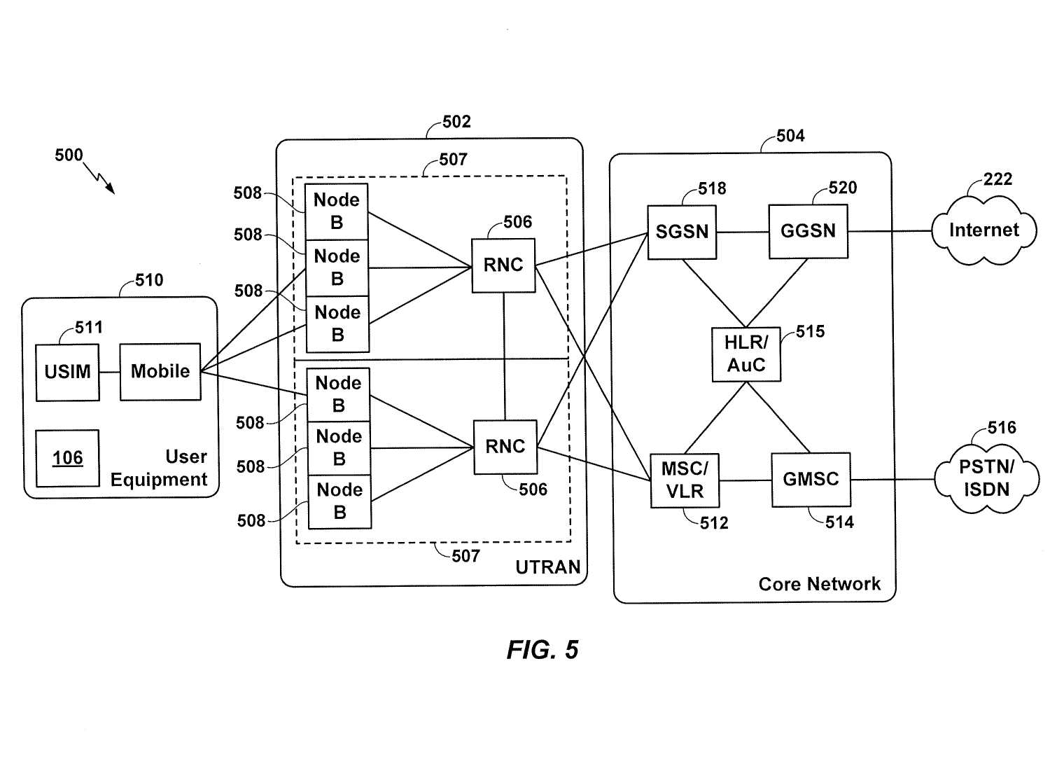

The various concepts presented throughout this disclosure may be implemented across a broad variety of telecommunication systems, network architectures, and communication standards. By way of example and without limitation, the aspects of the present disclosure illustrated in FIG. 5 are presented with reference to a UMTS system 500 employing a W-CDMA air interface. A UMTS network includes three interacting domains: a Core Network (CN) 504, a UMTS Terrestrial Radio Access Network (UTRAN) 502, and User Equipment (UE) 510. In an aspect, UE 510 may represent UE 102 of FIG. 1 and can include operational mode manager 106 of FIGS. 1 and 2. In this example, the UTRAN 502 provides various wireless services including telephony, video, data, messaging, broadcasts, and/or other services. The UTRAN 502 may include a plurality of Radio Network Subsystems (RNSs) such as an RNS 507, each controlled by a respective Radio Network Controller (RNC) such as an RNC 506. Here, the UTRAN 502 may include any number of RNCs 506 and RNSs 507 in addition to the RNCs 506 and RNSs 507 illustrated herein. The RNC 506 is an apparatus responsible for, among other things, assigning, reconfiguring and releasing radio resources within the RNS 507. The RNC 506 may be interconnected to other RNCs (not shown) in the UTRAN 502 through various types of interfaces such as a direct physical connection, a virtual network, or the like, using any suitable transport network.

Communication between a UE 510 and a Node B 508 may be considered as including a physical (PHY) layer and a medium access control (MAC) layer. Further, communication between a UE 510 and an RNC 506 by way of a respective Node B 508 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in Radio Resource Control (RRC) Protocol Specification, 3GPP TS 25.331 v9.1.0, incorporated herein by reference.

The geographic region covered by the SRNS 507 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 508 are shown in each SRNS 507; however, the SRNSs 507 may include any number of wireless Node Bs. The Node Bs 508 provide wireless access points to a core network (CN) 504 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 510 may further include a universal subscriber identity module (USIM) 511, which contains a user's subscription information to a network. For illustrative purposes, one UE 510 is shown in communication with a number of the Node Bs 508. The downlink (DL), also called the forward link, refers to the communication link from a Node B 508 to a UE 510, and the uplink (UL), also called the reverse link, refers to the communication link from a UE 510 to a Node B 508.

The core network 504 interfaces with one or more access networks, such as the UTRAN 502. As shown, the core network 504 is a GSM core network. However, as those skilled in the art will recognize, the various concepts presented throughout this disclosure may be implemented in a RAN, or other suitable access network, to provide UEs with access to types of core networks other than GSM networks.

The core network 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 504 supports circuit-switched services with a MSC 512 and a GMSC 514. In some applications, the GMSC 514 may be referred to as a media gateway (MGW). One or more RNCs, such as the RNC 506, may be connected to the MSC 512. The MSC 512 is an apparatus that controls call setup, call routing, and UE mobility functions. The MSC 512 also includes a visitor location register (VLR) that contains subscriber-related information for the duration that a UE is in the coverage area of the MSC 512. The GMSC 514 provides a gateway through the MSC 512 for the UE to access a circuit-switched network 516. The core network 504 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The core network 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 510 through the SGSN 518, which performs primarily the same functions in the packet-based domain as the MSC 512 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a Node B 508 and a UE 510. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

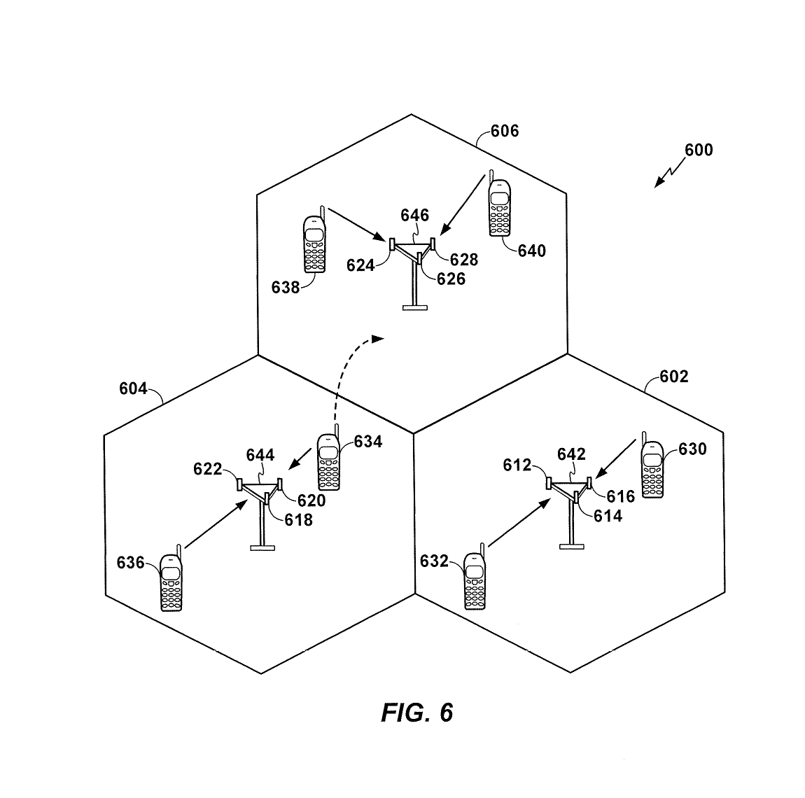

Referring to FIG. 6, an access network 600 in a UTRAN architecture is illustrated. In an aspect, access network 600 which may correspond to network 108 of FIG. 1 or a portion thereof. In other words, the UTRAN architecture may be associated with a network configured to serve UE 102 of FIG. 1. The multiple access wireless communication system includes multiple cellular regions (cells), including cells 602, 604, and 606, each of which may include one or more sectors. The multiple sectors can be formed by groups of antennas with each antenna responsible for communication with UEs in a portion of the cell. For example, in cell 602, antenna groups 612, 614, and 616 may each correspond to a different sector. In cell 604, antenna groups 618, 620, and 622 each correspond to a different sector. In cell 606, antenna groups 624, 626, and 628 each correspond to a different sector. The cells 602, 604 and 606 may include several wireless communication devices, e.g., User Equipment or UEs, which may be in communication with one or more sectors of each cell 602, 604 or 606, which may represent UE 102 of FIG. 1 having a operational mode manager 106. For example, UEs 630 and 632 may be in communication with Node B 642, UEs 634 and 636 may be in communication with Node B 644, and UEs 638 and 640 (which may represent UE 102 of FIG. 1) can be in communication with Node B 646. Here, each Node B 642, 644, 646 is configured to provide an access point to a core network 204 (see FIG. 2) for all the UEs 630, 632, 634, 636, 638, 640 in the respective cells 602, 604, and 606.

As the UE 634 moves from the illustrated location in cell 604 into cell 606, a serving cell change (SCC) or handover may occur in which communication with the UE 634 transitions from the cell 604, which may be referred to as the source cell, to cell 606, which may be referred to as the target cell. Management of the handover procedure may take place at the UE 634, at the Node Bs corresponding to the respective cells, at a radio network controller 506 (see FIG. 5), or at another suitable node in the wireless network. For example, during a call with the source cell 604, or at any other time, the UE 634 may monitor various parameters of the source cell 604 as well as various parameters of neighboring cells such as cells 606 and 602. Further, depending on the quality of these parameters, the UE 634 may maintain communication with one or more of the neighboring cells. During this time, the UE 634 may maintain an Active Set, that is, a list of cells that the UE 634 is simultaneously connected to (i.e., the UTRA cells that are currently assigning a downlink dedicated physical channel DPCH or fractional downlink dedicated physical channel F-DPCH to the UE 634 may constitute the Active Set).

The modulation and multiple access scheme employed by the access network 600 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 6rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 6GPP organization. CDMA2000 and UMB are described in documents from the 6GPP2 organization. The actual wireless communication standard and the multiple access technology employed will depend on the specific application and the overall design constraints imposed on the system.

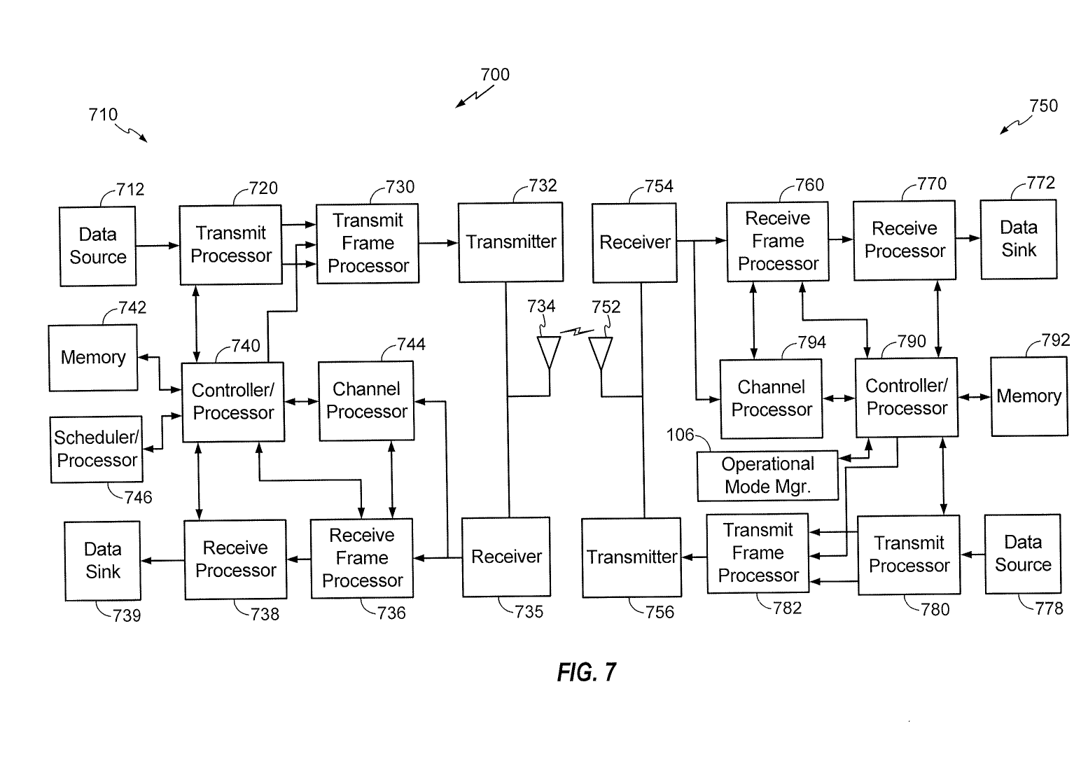

FIG. 7 is a block diagram of a Node B 710 in communication with a UE 750, where the Node B 710 may be associated with network 108 in FIG. 1, and the UE 750 may be the UE 102 of FIG. 1. Accordingly, UE 750 may include an operational mode manager 106, for example, as described in reference to FIGS. 1 and 2. In the downlink communication, a transmit processor 720 may receive data from a data source 712 and control signals from a controller/processor 740. The transmit processor 720 provides various signal processing functions for the data and control signals, as well as reference signals (e.g., pilot signals). For example, the transmit processor 720 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 744 may be used by a controller/processor 740 to determine the coding, modulation, spreading, and/or scrambling schemes for the transmit processor 720. These channel estimates may be derived from a reference signal transmitted by the UE 750 or from feedback from the UE 750. The symbols generated by the transmit processor 720 are provided to a transmit frame processor 730 to create a frame structure. The transmit frame processor 730 creates this frame structure by multiplexing the symbols with information from the controller/processor 740, resulting in a series of frames. The frames are then provided to a transmitter 732, which provides various signal conditioning functions including amplifying, filtering, and modulating the frames onto a carrier for downlink transmission over the wireless medium through antenna 734. The antenna 734 may include one or more antennas, for example, including beam steering bidirectional adaptive antenna arrays or other similar beam technologies.

At the UE 750, a receiver 754 receives the downlink transmission through an antenna 752 and processes the transmission to recover the information modulated onto the carrier. The information recovered by the receiver 754 is provided to a receive frame processor 760, which parses each frame, and provides information from the frames to a channel processor 794 and the data, control, and reference signals to a receive processor 770. The receive processor 770 then performs the inverse of the processing performed by the transmit processor 720 in the Node B 710. More specifically, the receive processor 770 descrambles and despreads the symbols, and then determines the most likely signal constellation points transmitted by the Node B 710 based on the modulation scheme. These soft decisions may be based on channel estimates computed by the channel processor 794. The soft decisions are then decoded and deinterleaved to recover the data, control, and reference signals. The CRC codes are then checked to determine whether the frames were successfully decoded. The data carried by the successfully decoded frames will then be provided to a data sink 772, which represents applications running in the UE 750 and/or various user interfaces (e.g., display). Control signals carried by successfully decoded frames will be provided to a controller/processor 790. When frames are unsuccessfully decoded by the receiver processor 770, the controller/processor 790 may also use an acknowledgement (ACK) and/or negative acknowledgement (NACK) protocol to support retransmission requests for those frames.

In the uplink, data from a data source 778 and control signals from the controller/processor 790 are provided to a transmit processor 780. The data source 778 may represent applications running in the UE 750 and various user interfaces (e.g., keyboard). Similar to the functionality described in connection with the downlink transmission by the Node B 710, the transmit processor 780 provides various signal processing functions including CRC codes, coding and interleaving to facilitate FEC, mapping to signal constellations, spreading with OVSFs, and scrambling to produce a series of symbols. Channel estimates, derived by the channel processor 794 from a reference signal transmitted by the Node B 710 or from feedback contained in the midamble transmitted by the Node B 710, may be used to select the appropriate coding, modulation, spreading, and/or scrambling schemes. The symbols produced by the transmit processor 780 will be provided to a transmit frame processor 782 to create a frame structure. The transmit frame processor 782 creates this frame structure by multiplexing the symbols with information from the controller/processor 790, resulting in a series of frames. The frames are then provided to a transmitter 756, which provides various signal conditioning functions including amplification, filtering, and modulating the frames onto a carrier for uplink transmission over the wireless medium through the antenna 752.

The uplink transmission is processed at the Node B 710 in a manner similar to that described in connection with the receiver function at the UE 750. A receiver 735 receives the uplink transmission through the antenna 734 and processes the transmission to recover the information modulated onto the carrier. The information recovered by the receiver 735 is provided to a receive frame processor 736, which parses each frame, and provides information from the frames to the channel processor 744 and the data, control, and reference signals to a receive processor 738. The receive processor 738 performs the inverse of the processing performed by the transmit processor 780 in the UE 750. The data and control signals carried by the successfully decoded frames may then be provided to a data sink 739 and the controller/processor, respectively. If some of the frames were unsuccessfully decoded by the receive processor, the controller/processor 740 may also use an acknowledgement (ACK) and/or negative acknowledgement (NACK) protocol to support retransmission requests for those frames.

The controller/processors 740 and 790 may be used to direct the operation at the Node B 710 and the UE 750, respectively. For example, the controller/processors 740 and 790 may provide various functions including timing, peripheral interfaces, voltage regulation, power management, and other control functions. The computer readable media of memories 742 and 792 may store data and software for the Node B 710 and the UE 750, respectively. A scheduler/processor 746 at the Node B 710 may be used to allocate resources to the UEs and schedule downlink and/or uplink transmissions for the UEs.

Several aspects of a telecommunications system have been presented with reference to an HSPA system. As those skilled in the art will readily appreciate, various aspects described throughout this disclosure may be extended to other telecommunication systems, network architectures and communication standards.

By way of example, various aspects may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” or “component” that includes or is configured to communicate with one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more components herein or processors in the processing system may include hardware and may be configured to execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods or methodologies described herein may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, or 35 U.S.C. §112(f), whichever is appropriate, unless the element is expressly recited using the phrase “means for” or, in the case of a method claim, the element is recited using the phrase “step for.”

1. A method of user equipment (UE) management, comprising:
detecting a first trigger event;
transitioning an operational mode of the UE from a first mode to a second mode based on detecting the first trigger event, wherein a paging cycle rate and a cell measurement rate of the UE are based on the operational mode;
monitoring a paging channel of a serving cell associated with the UE according to the paging cycle rate while the UE is operating according to the second mode;
performing cell measurement of one or more available cells according to the cell measurement rate while the UE is operating according to the second mode;
detecting a second trigger event while the UE is operating according to the second mode; and
transitioning the operational mode of the UE from the second mode to the first mode based on detecting the second trigger event.

2. The method of claim 1, wherein:
the first mode comprises a passive mode in which the paging cycle rate is less than a paging signal transmission rate associated with the paging channel and the cell measurement rate is less than a cell information transmission rate associated with the one or more available cells; and
the second mode comprises an active mode in which the paging cycle rate conforms to the paging signal transmission rate associated with the paging channel and the cell measurement rate conforms to the cell information transmission rate associated with the one or more available cells.

3. The method of claim 1, wherein:
the second mode comprises a passive mode in which the paging cycle rate is less than a paging signal transmission rate associated with the paging channel and the cell measurement rate is less than a cell information transmission rate associated with the one or more available cells; and
the first mode comprises an active mode in which the paging cycle rate conforms to the paging signal transmission rate associated with the paging channel and the cell measurement rate conforms to the cell information transmission rate associated with the one or more available cells.

4. The method of claim 1, wherein at least one of the first trigger event and the second trigger event comprises receiving a message from a server, wherein the message indicates that data stored on the server is to be transmitted to the UE.

5. The method of claim 1, wherein at least one of the first trigger event and the second trigger event comprises determining that a current time of day corresponds to a mode transition time of day.

6. The method of claim 5, further comprising:
receiving the mode transition time of day from a server;
storing the mode transition time of day in a memory associated with the UE.

7. The method of claim 1, further comprising:
receiving, from a server, at least one of a first mode timer and a second mode timer, wherein the first mode timer defines a first time period during which the UE is to remain in the first mode and the second mode timer defines a second time period during which the UE is to remain in the second mode,
wherein detecting the first trigger event comprises determining that the first mode timer has expired; and
wherein detecting the second trigger event comprises determining that the second mode timer has expired.

8. The method of claim 1, further comprising:
receiving at least one System Information Block (SIB) associated with the one or more available cells, wherein each of the at least one SIB indicates a cell size associated with one of the one or more available cells;
determining a largest cell size associated with the one or more available cells; and
performing a reselection procedure to establish a largest available cell corresponding to the largest cell size as the serving cell of the UE regardless of a mobility state of the UE.

9. The method of claim 8, wherein the mobility state of the UE comprises a low mobility state.

10. The method of claim 8, wherein the mobility state of the UE comprises a high mobility state.

11. The method of claim 1, wherein one or more of the serving cell and the one or more available cells operate according to a Hierarchical Cell Structure (HCS).

12. The method of claim 11, wherein each of the at least one SIB comprises HCS information that indicates the cell size.

13. An apparatus for mobile communication, comprising:
means for detecting a first trigger event;
means for transitioning an operational mode of a user equipment (UE) from a first mode to a second mode based on detecting the first trigger event, wherein a paging cycle rate and a cell measurement rate of the UE are based on the operational mode of the UE;
means for monitoring a paging channel of a serving cell associated with the UE according to the paging cycle rate while the UE is operating according to the second mode;
means for performing cell measurement of one or more available cells according to the cell measurement rate while the UE is operating according to the second mode;
means for detecting a second trigger event while the UE is operating according to the second mode; and
means for transitioning the operational mode of the UE from the second mode to the first mode based on detecting the second trigger event.

14. The apparatus of claim 13, wherein:
one of the first mode and the second mode comprises a passive mode in which the paging cycle rate is less than a paging signal transmission rate associated with the paging channel and the cell measurement rate is less than a cell information transmission rate associated with the one or more available cells; and
one of the first mode and the second mode comprises an active mode in which the paging cycle rate conforms to the paging signal transmission rate associated with the paging channel and the cell measurement rate conforms to the cell information transmission rate associated with the one or more available cells.

15. The apparatus of claim 13, further comprising:
means for receiving at least one System Information Block (SIB) associated with the one or more available cells, wherein each of the at least one SIB indicates a cell size associated with one of the one or more available cells;
means for determining a largest cell size associated with the one or more available cells; and
means for performing a reselection procedure to establish a largest available cell corresponding to the largest cell size as the serving cell of the UE regardless of a mobility state of the UE.

16. A non-transitory computer-readable storage medium, comprising instructions, that when executed by a processor, cause the processor to perform:
detecting a first trigger event;
transitioning an operational mode of a user equipment (UE) from a first mode to a second mode based on detecting the first trigger event, wherein a paging cycle rate and a cell measurement rate of the UE are based on the operational mode;
monitoring a paging channel of a serving cell associated with the UE according to the paging cycle rate while the UE is operating according to the second mode;
performing cell measurement of one or more available cells according to the cell measurement rate while the UE is operating according to the second mode;
detecting a second trigger event while the UE is operating according to the second mode; and
transitioning the operational mode of the UE from the second mode to the first mode based on detecting the second trigger event.

17. The non-transitory computer-readable storage medium of claim 16, wherein:
one of the first mode and the second mode comprises a passive mode in which the paging cycle rate is less than a paging signal transmission rate associated with the paging channel and the cell measurement rate is less than a cell information transmission rate associated with the one or more available cells; and
one of the first mode and the second mode comprises an active mode in which the paging cycle rate conforms to the paging signal transmission rate associated with the paging channel and the cell measurement rate conforms to the cell information transmission rate associated with the one or more available cells.

18. The non-transitory computer-readable storage medium of claim 16, further comprising instructions, that when executed by the processor, cause the processor to perform:
receiving at least one System Information Block (SIB) associated with the one or more available cells, wherein each of the at least one SIB indicates a cell size associated with one of the one or more available cells;
determining a largest cell size associated with the one or more available cells; and
performing a reselection procedure to establish a largest available cell corresponding to the largest cell size as the serving cell of the UE regardless of a mobility state of the UE.

19. An apparatus for wireless communication, comprising:
a trigger event detecting component configured to detect a first trigger event and a second trigger event;
an operational mode transitioning component configured to transition an operational mode of a user equipment (UE) from a first mode to a second mode based on detecting the first trigger event and configured to transition the operational mode from the second mode to the first mode based on detecting the second trigger event, wherein a paging cycle rate and a cell measurement rate of the UE are based on the operational mode of the UE;
a paging channel monitoring component configured to monitor a paging channel of a serving cell associated with the UE according to the paging cycle rate while the UE is operating according to the second mode; and
a cell measurement component configured to perform cell measurement of one or more available cells according to the cell measurement rate while the UE is operating according to the second mode;

20. The apparatus of claim 19, wherein:
the first mode comprises a passive mode in which the paging cycle rate is less than a paging signal transmission rate associated with the paging channel and the cell measurement rate is less than a cell information transmission rate associated with the one or more available cells; and
the second mode comprises an active mode in which the paging cycle rate conforms to the paging signal transmission rate associated with the paging channel and the cell measurement rate conforms to the cell information transmission rate associated with the one or more available cells.

21. The apparatus of claim 19, wherein:
the second mode comprises a passive mode in which the paging cycle rate is less than a paging signal transmission rate associated with the paging channel and the cell measurement rate is less than a cell information transmission rate associated with the one or more available cells; and
the first mode comprises an active mode in which the paging cycle rate conforms to the paging signal transmission rate associated with the paging channel and the cell measurement rate conforms to the cell information transmission rate associated with the one or more available cells.

22. The apparatus of claim 19, further comprising a receiver configured to receive a message from a server, wherein the message indicates that data stored on the server is to be transmitted to the UE.

23. The apparatus of claim 19, wherein the trigger event detecting component is further configured to determine that a current time of day corresponds to a mode transition time of day.

24. The apparatus of claim 23, further comprising:
a receiver configured to receive a mode transition time of day from a server;
a memory configured to store the mode transition time of day.

25. The apparatus of claim 19, further comprising:
a receiver configured to receive, from a server, at least one of a first mode timer and a second mode timer, wherein the first mode timer defines a first time period during which the UE is to remain in the first mode and the second mode timer defines a second time period during which the UE is to remain in the second mode,
wherein the trigger event detecting component is configured to determine that the first mode timer has expired and that the second mode timer has expired.

26. The apparatus of claim 19, further comprising:
a receiver configured to receive at least one System Information Block (SIB) associated with the one or more available cells, wherein each of the at least one SIB indicates a cell size associated with one of the one or more available cells;
a largest cell size determining component configured to determine a largest cell size associated with the one or more available cells; and
a reselection component configured to perform a reselection procedure to establish a largest available cell corresponding to the largest cell size as the serving cell of the UE regardless of a mobility state of the UE.

27. The apparatus of claim 26, wherein the mobility state comprises a low mobility state.

28. The apparatus of claim 26, wherein the mobility state comprises a high mobility state.

29. The apparatus of claim 19, wherein one or more of the serving cell and the one or more available cells operate according to a Hierarchical Cell Structure (HCS).

30. The apparatus of claim 29, wherein each of the at least one SIB comprises HCS information that indicates the cell size.
